(19) United States
(12) Patent Application Publication
(10) Pub. No.: US 2026/0187655 A1
(43) Pub. Date: Jul. 2, 2026

(54) HARDWARE-ANCHORED REGULATORY CAPITAL ADAPTATION AND REAL-TIME POLICY ORCHESTRATION ENGINE WITH ATTESTATION-BOUND COMPLIANCE AUTOMATION

(71) Applicant: George William Bickerstaff, III, Greenwich, CT (US)

(72) Inventor: George William Bickerstaff, III, Greenwich, CT (US)

(21) Appl. No.: 19/547,623

(22) Filed: Feb. 23, 2026

(51) Int. Cl. G06Q 30/018; G06Q 40/02

(52) U.S. Cl. CPC G06Q 30/018; G06Q 40/02

(57) ABSTRACT

A hardware-anchored Regulatory Capital Adaptation and Policy Orchestration Engine executes regulatory update ingestion, cryptographic source verification, policy translation, and capital compliance enforcement entirely within trusted execution environments (TEEs) comprising Intel SGX enclaves, AMD SEV-SNP protected VMs, or ARM TrustZone secure worlds, materially altering processor states to isolate all policy and compliance computation. Regulatory updates are cryptographically verified against External Regulatory Authority public keys and translated into executable policy coefficients committed to a TEE-Sealed Policy Store with new TEE attestation reports binding each update to the hardware environment. A Policy Drift Monitor anchored to TEE-resident hardware mechanisms detects unauthorized policy modifications. A Regulatory Compliance Vector is computed using r(lambda, mu, nu, kappa) and evaluated by a non-bypassable Compliance Enforcement Gate prior to transaction authorization. A ZKP Compliance Verification Engine generates Groth16 proofs of approximately 192 bytes verifiable in under 10 milliseconds, each embedding TEE-Sealed Policy Store attestation identifiers enabling regulators to verify both compliance outcomes and the specific regulatory parameter versions that governed them. An Attestation-Bound Provenance Ledger binds all compliance events to TEE attestation reports.

### FIELD OF THE INVENTION

This invention relates to hardware-secured artificial intelligence systems for automated regulatory capital compliance, policy adaptation, and cross-jurisdictional financial rule enforcement, specifically to a Regulatory Capital Adaptation and Policy Orchestration Engine that dynamically ingests authenticated regulatory rule changes, translates them into executable policy constraints, and enforces real-time capital adequacy and liquidity compliance as hardware-level execution conditions for financial operations entirely within a Trusted Execution Environment (TEE) comprising an Intel SGX enclave, AMD SEV-SNP protected virtual machine, or ARM TrustZone secure world that materially alters the processor state by invoking secure enclave isolation. This application cross-references U.S. Patent Application No. 17/987654, the entire contents of which are incorporated herein by reference for hardware-attested workflow enforcement mechanisms, and U.S. Patent Application Nos. 212041-LCF-003 and 212041-SCD-004, the contents of which are incorporated by reference for TEE-attested liquidity containment and systemic contagion detection mechanisms.

### BACKGROUND OF THE INVENTION

Financial institutions operate under a continuously evolving mosaic of regulatory capital frameworks—including Basel III and its forthcoming Basel IV revisions, domestic Liquidity Coverage Ratio standards, Net Stable Funding Ratio requirements, stress capital buffer regimes, and jurisdiction-specific supervisory rules that frequently diverge in timing, magnitude, and implementation detail from their international counterparts. A large globally active bank may simultaneously operate under capital requirements issued by the Federal Reserve, the European Banking Authority, the Prudential Regulation Authority, and multiple other supervisory bodies, each of which issues rule changes on its own schedule and in its own format. Under current practice, every rule change triggers a manual compliance workflow: compliance teams interpret the regulatory text, determine which internal systems and capital calculations are affected, manually update configuration parameters in those systems, and validate the changes through an audit cycle that can take days to weeks to complete. During this implementation lag, the institution's capital calculations may reflect outdated regulatory parameters, creating a window of non-compliance that neither the institution nor its regulators can detect with certainty.

Existing compliance engines address this problem by operating as software-level configuration management systems—repositories of rule parameters that compliance teams update when regulatory changes are issued. These systems have two fundamental deficiencies. First, because they operate on general-purpose hardware within a standard software stack, their parameter values are subject to administrative override, misconfiguration, and silent drift: a configuration parameter that was correctly set to reflect a Basel III capital multiplier can be modified by a system administrator or overwritten by a software deployment without generating any compliance-specific audit record. Second, because these systems are not hardware-isolated, there is no cryptographic proof that a given capital calculation was performed using the regulatory parameters that were in effect at the time—only an administrative assertion that the correct parameters were configured. For regulators, auditors, and counterparties, this means that every compliance attestation rests on a chain of administrative trust rather than a chain of hardware-anchored cryptographic verification.

Automated regulatory data feeds and RegTech platforms have emerged to accelerate the delivery of regulatory updates to compliance systems, but they address only the information delivery layer of the problem, not the enforcement layer. A platform that delivers a Basel IV capital multiplier update to a compliance team's dashboard in real time does not ensure that the updated multiplier is enforced as a hardware-level precondition to the next capital deployment. The gap between regulatory update delivery and enforcement-level application remains a software workflow gap—subject to the same administrative lag, misconfiguration risk, and non-repudiability deficiency as legacy compliance systems. Blockchain-based compliance ledgers record compliance events immutably but face the same limitation: they cannot bind a recorded capital calculation to the specific hardware environment and policy parameters that governed it, because they operate at the application layer of a general-purpose computing stack.

There remains a fundamental need for a system that ingests regulatory rule changes in real time, cryptographically verifies their authenticity against regulatory authority public keys, translates them into machine-executable capital policy constraints inside hardware-isolated TEE environments, commits the translated constraints to a TEE-sealed policy store that cannot be modified outside the hardware isolation boundary, and enforces those constraints as hardware-level preconditions to every regulated transaction—with every policy update, compliance computation, and enforcement decision cryptographically bound to the TEE attestation report of the hardware environment that performed it. This invention provides that system.

### SUMMARY OF THE INVENTION

This invention is a Regulatory Capital Adaptation and Policy Orchestration Engine—a system that closes the gap between regulatory rule issuance and enforcement-level application by executing the entire compliance automation pipeline inside tamper-proof hardware, making every regulatory parameter update cryptographically verifiable, every capital compliance calculation hardware-attested, and every enforcement decision non-bypassable. Think of it as moving the compliance department's rule interpretation and parameter configuration function into the same hardware vault that performs the capital calculations—so that a regulatory update is not just received and manually applied, but cryptographically verified, automatically translated, and immediately enforced as a hardware-level execution condition, with the entire sequence documented in a provenance record that regulators can verify independently in milliseconds.

The core technical problem solved by this invention is the implementation lag and administrative trust dependency of existing regulatory compliance systems. Today, a regulatory capital rule change must be manually interpreted, manually configured, and manually validated before it affects any transaction—a process that takes days to weeks and produces a compliance record that cannot be cryptographically verified. This invention eliminates all three manual steps: the Policy Translation Engine verifies the regulatory source cryptographically and translates the rule automatically inside the TEE; the TEE-Sealed Policy Store commits the translated parameters with a new hardware attestation event so the update is immediately enforceable; and the Compliance Enforcement Gate applies the updated parameters to every regulated transaction as a hardware-level precondition, with no administrative action required. The entire sequence is governed by the regulatory compliance function r(lambda, mu, nu, kappa) where lambda represents the institution's current capital position derived from hardware-attested balance sheet inputs, mu represents active regulatory capital multipliers from the TEE-Sealed Policy Store, nu represents applicable stress capital buffer coefficients, and kappa represents the applicable minimum capital adequacy threshold, such that the output of r constitutes the Regulatory Compliance Vector for the institution at the time of the TEE Execution Instance.

The primary technical mechanisms are three integrated hardware-enforced components. First, the Policy Translation Engine executes entirely within the TEE, verifying each incoming regulatory update's digital signature against the applicable regulatory authority's public key before parsing its content—ensuring that only authentic, unmodified regulatory updates are translated into executable policy coefficients and that no unauthorized party can inject false regulatory parameters into the TEE-Sealed Policy Store. Second, the Policy Drift Monitor anchors all policy integrity monitoring to TEE-resident hardware mechanisms—specifically, enclave-sealed monitoring registers, memory encryption engine integrity states, and attestation-based recalibration triggers—so that any unauthorized modification to the TEE-Sealed Policy Store's contents triggers a hardware-level alert that cannot be suppressed at the software layer. Third, the ZKP Compliance Verification Engine generates Groth16 arithmetic-circuit proofs inside the TEE allowing regulators and auditors to verify that a specific capital calculation was performed using the specific regulatory parameters that were in force at the time, without accessing the institution's proprietary capital position data.

The system additionally includes a Compliance Simulation Engine (also referred to herein as the Optimization and Simulation Engine, as labeled in FIG. 4) that stress-tests regulatory scenario impacts on the institution's capital position inside the TEE, and an append-only Attestation-Bound Provenance Ledger that cryptographically records every policy update, compliance computation, enforcement decision, and ZKP proof generation with hash-chain binding to TEE attestation reports. Together, these components create a closed loop: regulatory updates enter the TEE, are cryptographically verified and translated, are committed to the TEE-Sealed Policy Store with a new attestation event, drive updated Regulatory Compliance Vector computations, and are enforced by the Compliance Enforcement Gate—with every step permanently recorded in the Provenance Ledger, all within the hardware isolation boundary.

The invention provides a measurable technological improvement over existing systems by: (a) materially altering the computer processor's execution state by invoking hardware-isolated TEE enclaves to isolate and transform regulatory rule translation and capital compliance computation data; (b) anchoring policy configuration integrity monitoring to physical hardware registers inside the TEE so that regulatory parameter values cannot be silently modified without triggering a hardware alert; and (c) combining automated regulatory rule translation, hardware-enforced policy commitment, and attestation-bound compliance gating into a unified architecture that no prior system achieves. This combination satisfies 35 U.S.C. Section 101 as a concrete technical improvement to computer security and regulatory compliance data processing, and demonstrates non-obviousness under 35 U.S.C. Section 103 because the combination produces results—specifically, real-time hardware-level enforcement of regulatory capital requirements with cryptographically verifiable compliance proofs and zero administrative implementation lag—that no predictable combination of rule engines, blockchain ledgers, compliance dashboards, or manual compliance workflows achieves. The claimed architecture reduces computational redundancy in regulatory reporting workflows by replacing manual rule interpretation cycles and periodic compliance audit processes with constant-size cryptographic verification operations executed in hardware-isolated environments.

### BRIEF DESCRIPTION OF THE DRAWINGS

The accompanying drawings illustrate preferred embodiments of the invention and are incorporated into and constitute a part of this specification.

FIG. 1 illustrates the overall system architecture, including subfigures:

FIG. 1A—Regulatory Feed Ingestion Gate;

FIG. 1B—Policy Translation Engine;

FIG. 1C—Compliance Enforcement Gate;

FIG. 1D—ZKP Compliance Verification Engine;

FIG. 1E—Attestation-Bound Provenance Ledger.

FIG. 2 depicts the policy adaptation pipeline, including subfigures:

FIG. 2A—Source Authentication Module;

FIG. 2B—Rule Parsing Engine;

FIG. 2C—Coefficient Generator;

FIG. 2D—TEE-Sealed Policy Store;

FIG. 2E—Policy Drift Monitor.

FIG. 3 shows the security and drift monitoring flow, including subfigures:

FIG. 3A—TEE Isolation Layer;

FIG. 3B—Enclave-Sealed Register Interface;

FIG. 3C—Memory Encryption Engine;

FIG. 3D—Attestation Report Generator;

FIG. 3E—Policy Drift Monitor.

FIG. 4 illustrates the Compliance Simulation Engine (also referred to herein as the Optimization and Simulation Engine), including subfigures:

FIG. 4A—Compliance Simulation Engine;

FIG. 4B—Regulatory Scenario Stress Tester;

FIG. 4C—RCV Calibration Loop;

FIG. 4D—Capital Impact Modeler;

FIG. 4E—Policy Coefficient Recalibrator.

FIG. 5 depicts the cross-jurisdictional verification and reporting layer, including subfigures:

FIG. 5A—Multi-Jurisdiction Verifier;

FIG. 5B—ZKP Distribution Coordinator;

FIG. 5C—Regulatory Reporting Interface;

FIG. 5D—Rollback Controller;

FIG. 5E—Final Compliance Seal.

### DETAILED DESCRIPTION OF THE INVENTION

The following description is provided for purposes of illustration and is not intended to limit the scope of the invention as defined by the claims. Embodiments may be implemented in hardware, software, or a combination thereof.

### Definitions

The following terms are used consistently throughout this specification:

Attestation-Bound Provenance Ledger: A permanent, append-only record of every regulatory update ingestion event, Policy Translation Engine verification and translation outcome, TEE-Sealed Policy Store commitment, Regulatory Compliance Vector computation, Compliance Enforcement Gate authorization or denial, ZKP proof generation, and Rollback Controller reversion processed by the system (also referred to herein as the Provenance Ledger). It is structured as a cryptographic hash chain in which each new entry is mathematically linked to the entry before it, so that any attempt to alter, delete, or reorder a past entry propagates as a detectable inconsistency through all subsequent entries. Each ledger entry is cryptographically bound to a TEE attestation report that certifies the hardware environment and software configuration of the TEE at the time the associated computation was performed, enabling independent verification of both the compliance outcome and the specific hardware execution environment that produced it.

Compliance Enforcement Gate: A TEE-resident non-bypassable hardware execution barrier that enforces active regulatory capital requirements as hardware-level preconditions to regulated transaction authorization. The Compliance Enforcement Gate evaluates the Regulatory Compliance Vector against capital adequacy thresholds and liquidity coverage requirements retrieved from the TEE-Sealed Policy Store and permits transaction authorization only when all of the following conditions are satisfied within a single TEE Execution Instance prior to enclave termination: (i) the Regulatory Compliance Vector satisfies all applicable capital adequacy thresholds; (ii) the Policy Drift Monitor confirms that TEE-Sealed Policy Store contents have not been modified outside the hardware isolation boundary since the last attested policy commitment; (iii) the active regulatory parameters in the TEE-Sealed Policy Store are bound to a current TEE attestation report; and (iv) the ZKP Compliance Verification Engine has generated a valid proof of compliance. This gate executes within a TEE to ensure that regulatory capital enforcement cannot be bypassed by software-level administrative override outside the hardware isolation boundary.

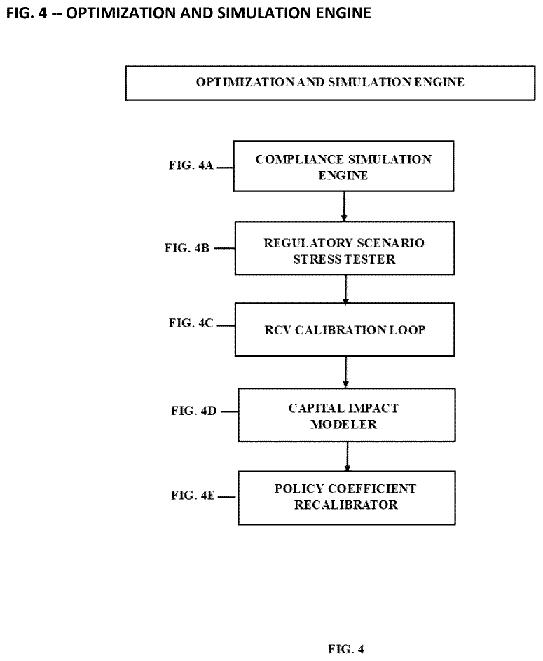

Compliance Simulation Engine: A TEE-resident regulatory scenario analysis and capital impact modeling component (also referred to herein as the Optimization and Simulation Engine, as labeled in FIG. 4) that executes forward-looking regulatory scenario simulations, stress capital buffer impact analyses, and cross-jurisdiction compliance projection scenarios entirely within the hardware isolation boundary of the TEE. The Compliance Simulation Engine uses hardware-attested Regulatory Compliance Vector values, active regulatory parameters from the TEE-Sealed Policy Store, and proposed future regulatory coefficient scenarios to model the institution's capital position under current and prospective regulatory environments, generating recalibration recommendations for the RCV Calibration Loop. All scenario outputs are cryptographically bound to the TEE attestation report of the hardware environment that produced them. This component executes within a TEE for protected, tamper-resistant regulatory compliance scenario modeling.

External Regulatory Authority: Any entity outside the TEE isolation boundary that issues authenticated regulatory capital requirements, liquidity standards, or supervisory rules to which the system applies, including without limitation the Federal Reserve, European Banking Authority, Prudential Regulation Authority, Bank for International Settlements, and applicable domestic financial regulatory bodies. An External Regulatory Authority interacts with the system by issuing digitally signed regulatory updates that the Policy Translation Engine ingests and cryptographically verifies inside the TEE. An External Regulatory Authority also receives ZKP compliance proofs and TEE attestation reports enabling independent verification of the institution's regulatory compliance without accessing proprietary capital position data.

Optimization and Simulation Engine: An alternate designation for the Compliance Simulation Engine, as labeled in FIG. 4. See Compliance Simulation Engine definition. Both designations refer to the same TEE-resident regulatory compliance scenario modeling and capital impact analysis component.

Policy Drift Monitor: A TEE-resident hardware monitoring component that continuously validates the integrity of the TEE-Sealed Policy Store's contents by reading hardware-derived integrity signals from TEE-resident hardware mechanisms—specifically, enclave-sealed monitoring registers, memory encryption engine integrity states, and attestation-based recalibration triggers. The Policy Drift Monitor detects any deviation in the TEE-Sealed Policy Store's regulatory coefficient values that was not introduced through an authenticated Policy Translation Engine commitment event—including unauthorized administrative modification, software-level parameter overwrite, or hardware-level tampering—and triggers a hardware-level policy integrity alert and suspends Compliance Enforcement Gate authorization until a Policy Translation Engine re-attestation cycle validates the store's current contents. The Policy Drift Monitor's state is stored in TEE-resident hardware registers physically inaccessible to software outside the TEE.

Policy Translation Engine: A TEE-resident module that receives incoming regulatory updates from the Regulatory Feed Ingestion Gate, verifies each update's digital signature against the issuing External Regulatory Authority's public key stored in the TEE-Sealed Policy Store, parses the verified regulatory text into structured executable policy coefficients including capital multipliers, liquidity coverage ratios, stress capital buffer requirements, and applicable minimum capital adequacy thresholds, and commits the translated coefficients to the TEE-Sealed Policy Store with an attestation-bound commitment record. Each policy commitment generates a new TEE attestation event binding the committed coefficients to the hardware environment in which the translation and verification were performed. The Policy Translation Engine executes within a TEE to ensure that only cryptographically authenticated regulatory updates can modify the TEE-Sealed Policy Store's operative coefficients.

Regulatory compliance vector (RCV): A hardware-attested multidimensional vector produced by the Regulatory Compliance Vector Engine that quantifies an institution's capital adequacy, liquidity coverage ratio compliance, and stress capital buffer alignment relative to the active regulatory parameters stored in the TEE-Sealed Policy Store. The RCV is computed using the regulatory compliance function r(lambda, mu, nu, kappa) where lambda represents the institution's current capital position derived from hardware-attested balance sheet inputs, mu represents active regulatory capital multipliers retrieved from the TEE-Sealed Policy Store, nu represents applicable stress capital buffer coefficients retrieved from the TEE-Sealed Policy Store, and kappa represents the applicable minimum capital adequacy threshold, such that the output of r constitutes the Regulatory Compliance Vector for the institution at the time of the TEE Execution Instance in which the computation was performed.

Regulatory Compliance Vector Engine: A TEE-resident AI computation module that generates the Regulatory Compliance Vector from hardware-attested capital position inputs using the regulatory compliance function r(lambda, mu, nu, kappa). The engine retrieves active regulatory coefficients (mu, nu, kappa) exclusively from the TEE-Sealed Policy Store and cannot be directed to use coefficients from any other source, ensuring that compliance calculations always reflect the current attested regulatory parameter state. The engine's computational model is sealed inside the TEE at initialization and cannot be silently modified between computation events. This engine executes within a TEE for hardware-anchored, non-repudiable regulatory compliance computation.

Regulatory Feed Ingestion Gate: The TEE-resident entry point where authenticated regulatory updates from External Regulatory Authorities arrive and are normalized, integrity-checked, and cryptographically transformed before entering the Policy Translation Engine pipeline. The gate enforces strict schema validation, rejects malformed or unauthenticated update objects, and ensures that all accepted regulatory updates are in a TEE-compatible secure format with preserved digital signature metadata before any downstream component processes them. No regulatory update exits the gate without cryptographic preservation of its original signature within the TEE.

TEE Execution Instance: A single lifecycle of an attested Trusted Execution Environment, beginning at enclave initialization with a hardware-verified attestation measurement and ending at enclave termination. All computations required to process a single regulated transaction authorization event—including Regulatory Compliance Vector computation, Policy Drift Monitor validation, Compliance Enforcement Gate evaluation, ZKP proof generation, and Provenance Ledger recording—are performed within a single TEE Execution Instance to guarantee that all operations are governed by the same attested hardware environment and policy parameter state, and that the resulting provenance record is cryptographically bound to that instance.

TEE-Sealed Policy Store: A hardware-protected storage repository within the TEE isolation boundary that holds the operative regulatory capital multipliers (mu), stress capital buffer coefficients (nu), liquidity coverage ratio thresholds, minimum capital adequacy thresholds (kappa), and External Regulatory Authority public keys used by the Policy Translation Engine for signature verification. The TEE-Sealed Policy Store can only be modified through an authenticated Policy Translation Engine commitment event that generates a new TEE attestation report binding the updated coefficients to the hardware environment. Any modification to the store's contents outside this pathway is detected by the Policy Drift Monitor and triggers a hardware-level integrity alert.

ZKP Compliance Verification Engine: A TEE-resident cryptographic component that generates and verifies zk-SNARK proofs (Zero-Knowledge Succinct Non-Interactive Arguments of Knowledge) using Groth16 arithmetic circuit structures. The ZKP Compliance Verification Engine allows the system to prove to an External Regulatory Authority or auditor that a Regulatory Compliance Vector was computed, that the RCV satisfied applicable regulatory capital thresholds, that the computation used the specific regulatory parameters committed to the TEE-Sealed Policy Store at the time of the relevant TEE Execution Instance, and that all computations were performed in a hardware-isolated environment—without revealing the institution's proprietary capital position data, internal model parameters, or counterparty exposure details. Proofs generated by this engine are approximately 192 bytes in size (under 1 KB) and verifiable in under 10 milliseconds on standard server-grade hardware due to the constant-size verification complexity property of Groth16 proofs independent of circuit depth. This engine executes within a TEE for secure, privacy-preserving regulatory compliance proof generation.

### How the System Works—Technology Overview

The system operates as a continuous real-time dual-pipeline architecture. The first pipeline—the policy adaptation pipeline—processes incoming regulatory updates: authenticated rule changes enter through the Regulatory Feed Ingestion Gate, are cryptographically verified and translated by the Policy Translation Engine inside the TEE, and are committed to the TEE-Sealed Policy Store with a new attestation event. The second pipeline—the compliance enforcement pipeline—processes regulated transaction authorizations: transaction requests trigger Regulatory Compliance Vector computation using the current TEE-Sealed Policy Store parameters, which are evaluated by the Compliance Enforcement Gate within a single TEE Execution Instance, with every outcome recorded in the Attestation-Bound Provenance Ledger. The two pipelines share the TEE-Sealed Policy Store as their integration point: every time the policy adaptation pipeline commits an authenticated regulatory update, the compliance enforcement pipeline immediately begins enforcing the updated parameters in all subsequent TEE Execution Instances, with zero administrative action required.

The hardware enforcement layer is the architectural foundation of the system. Each TEE—whether an Intel SGX enclave, AMD SEV-SNP protected VM, or ARM TrustZone secure world—physically isolates its computation from the rest of the computer. In all implementations, the Policy Drift Monitor draws its monitoring signals from TEE-resident hardware mechanisms that are physically inaccessible to software outside the TEE, including the host operating system and any virtualization layer. This means that a compromised software stack—including a rogue administrator, malicious hypervisor, or adversarial deployment update cannot modify the TEE-Sealed Policy Store's regulatory coefficients without triggering a hardware-level alert, cannot inject false regulatory parameters into the Policy Translation Engine, and cannot grant transaction authorizations that the Compliance Enforcement Gate has denied. The TEE-Sealed Policy Store's integrity is guaranteed not by administrative policy but by the hardware itself.

### Step-by-step Operation

Step 1—Regulatory Feed Ingestion: Authenticated regulatory updates from External Regulatory Authorities arrive at the Regulatory Feed Ingestion Gate, which executes inside a TEE. The gate normalizes each incoming update into a standardized schema, preserves the update's digital signature metadata, and cryptographically transforms the update into a TEE-compatible secure format. The gate enforces strict schema validation, rejecting malformed or unsigned update objects before they enter the Policy Translation Engine pipeline. No regulatory update exits the gate without cryptographic preservation of its original signature metadata within the TEE.

Step 2—Policy Translation and Attestation-Bound Policy Commitment: The Policy Translation Engine verifies each ingested update's digital signature against the issuing External Regulatory Authority's public key stored in the TEE-Sealed Policy Store, confirming the update's authenticity and integrity before any translation proceeds. Upon successful verification, the engine parses the regulatory text into structured executable policy coefficients—capital multipliers (mu), stress capital buffer coefficients (nu), liquidity coverage ratio thresholds, and minimum capital adequacy thresholds (kappa)—and commits the translated coefficients to the TEE-Sealed Policy Store through the Policy Commit Attestation Module. Each commitment generates a new TEE attestation report binding the updated coefficients to the hardware environment, and the commitment event is recorded in the Attestation-Bound Provenance Ledger.

Step 3—Policy Drift Monitoring and Validation: The Policy Drift Monitor continuously validates the integrity of the TEE-Sealed Policy Store by reading hardware-derived integrity signals from TEE-resident hardware mechanisms—specifically, enclave-sealed monitoring registers, memory encryption engine integrity states, and attestation-based recalibration triggers. The monitor confirms that the store's current regulatory coefficient values correspond to the coefficients committed in the most recent authenticated Policy Translation Engine commitment event. If any deviation is detected, the Policy Drift Monitor triggers a hardware-level policy integrity alert and suspends Compliance Enforcement Gate authorization until a Policy Translation Engine re-attestation cycle validates the store's contents.

Step 4—Regulatory Compliance Vector Computation: The Regulatory Compliance Vector Engine computes the Regulatory Compliance Vector inside the TEE using the regulatory compliance function r(lambda, mu, nu, kappa), incorporating the institution's hardware-attested current capital position (lambda), active regulatory capital multipliers from the TEE-Sealed Policy Store (mu), applicable stress capital buffer coefficients (nu), and the applicable minimum capital adequacy threshold (kappa). The resulting RCV is digitally signed and written as a pending entry to the Attestation-Bound Provenance Ledger.

Step 5—Compliance Enforcement Gate Evaluation: The Compliance Enforcement Gate evaluates all four authorization conditions—RCV satisfies applicable capital adequacy thresholds, Policy Drift Monitor integrity confirmation, TEE-Sealed Policy Store attestation currency, and ZKP proof availability—against the TEE-Sealed Policy Store parameters within the same TEE Execution Instance. If all conditions are satisfied, the gate issues a hardware-authorized transaction signal. If any condition fails, the Compliance Enforcement Gate blocks transaction authorization and routes the event to the Rollback Controller, which records the denial with full TEE attestation binding in the Attestation-Bound Provenance Ledger and reverts all pending pipeline state.

Step6—ZKP Proof Generation and Compliance Simulation and Scenario Analysis: The ZKP Compliance Verification Engine and Compliance Simulation Engine together perform ZKP proof generation and compliance simulation and scenario analysis on the authorized transaction data. The ZKP Compliance Verification Engine generates a Groth16 arithmetic-circuit proof inside the TEE encoding the fact that the RCV satisfied all applicable regulatory capital thresholds and that the computation used the specific regulatory parameters committed to the TEE-Sealed Policy Store at the time of the TEE Execution Instance, producing a proof of approximately 192 bytes that any External Regulatory Authority can verify in under 10 milliseconds without accessing the institution's proprietary capital position data. Simultaneously, the Compliance Simulation Engine models the capital position impact of the authorized transaction under prospective regulatory scenarios.

Step 7—Provenance Recording and Final Compliance Seal: The Attestation-Bound Provenance Ledger records the complete compliance computation and enforcement event as a new append-only hash chain entry, binding the RCV value, Policy Drift Monitor status, Compliance Enforcement Gate decision, ZKP proof reference, active regulatory parameter attestation identifiers, and Compliance Simulation Engine outputs to the TEE attestation report of the current TEE Execution Instance. The Final Compliance Seal applies an irreversible cryptographic closure to the completed transaction's compliance record, anchoring the terminal hash into the chain. The sealed compliance record is transmitted to the External Regulatory Authority's reporting system via the Regulatory Reporting Interface.

### Zero-knowledge Proof Implementation

The ZKP Compliance Verification Engine uses zk-SNARKs (Zero-Knowledge Succinct Non-Interactive Arguments of Knowledge)—a cryptographic proof type that enables the institution to prove regulatory compliance to any External Regulatory Authority without disclosing proprietary capital position data, internal model parameters, or counterparty exposure details. The non-interactive property is essential for regulatory reporting environments where compliance proofs may need to be submitted to multiple regulatory authorities simultaneously, each of which verifies independently using the same verification key without communication with the institution's systems after proof receipt. Arithmetic circuits encode the regulatory capital threshold conditions, RCV constraint criteria, and TEE-Sealed Policy Store attestation requirements that must be satisfied for a valid compliance proof, allowing the verifier to confirm that the capital calculation used the current authenticated regulatory parameters without accessing any underlying proprietary data.

The system implements zk-SNARKs using a trusted setup ceremony performed inside a TEE that generates a proving key and a verification key. The proving key is used by the institution's compliance system to generate per-transaction regulatory compliance proofs; the verification key is distributed to External Regulatory Authorities, auditors, and compliance verification systems. Both keys are generated inside the isolated TEE so that neither the institution's administrators nor any external party can tamper with the setup parameters. Keys are periodically rotated upon hardware attestation events or calendar triggers, and prior keys are invalidated using enclave-sealed revocation lists. The verification key also encodes a commitment to the current TEE-Sealed Policy Store attestation state, so that a verifier can confirm not just that the RCV satisfied the applicable thresholds, but that those thresholds were drawn from the most recently authenticated regulatory parameter update.

To generate a proof for a specific transaction authorization event, the system computes a mathematical value pi using the RCV, the active regulatory parameter attestation state, and applicable threshold conditions as private inputs along with the proving key. The computation occurs entirely inside the TEE. The resulting proof pi is transmitted to the External Regulatory Authority along with public inputs—for example, the applicable capital adequacy threshold range and the attestation identifier of the TEE-Sealed Policy Store update that established those parameters—without revealing the institution's proprietary capital position or model details. Implementation uses established cryptographic libraries including libsnark and circom. Groth16 proofs generated by this system are approximately 192 bytes in size and exhibit constant-size verification complexity independent of circuit depth, ensuring the under-10-millisecond verification bound holds across all supported compliance circuit configurations on standard server-grade hardware (e.g., a modern ×86-64 processor at 3 GHz or equivalent).

### Detailed Description of the Drawings

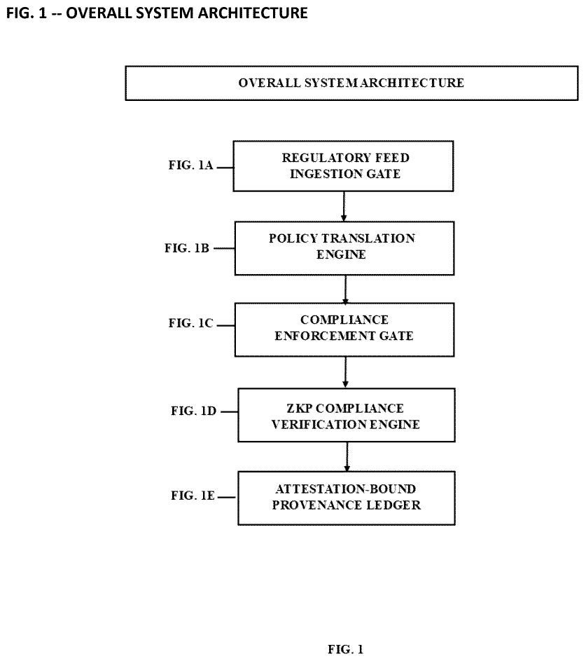

FIG. 1A —-Regulatory Feed Ingestion Gate: Shows the TEE-resident entry point where authenticated regulatory updates from External Regulatory Authorities arrive and are normalized, schema-validated, and cryptographically transformed with digital signature metadata preserved before entering the Policy Translation Engine pipeline. The gate enforces strict schema validation, rejects unsigned or malformed update objects, and ensures all accepted updates are in a TEE-compatible secure format. No regulatory update exits the gate without cryptographic preservation of its original signature metadata within the TEE isolation boundary.

FIG. 1B—Policy Translation Engine: Shows the core TEE-resident module that verifies incoming regulatory updates' digital signatures against External Regulatory Authority public keys stored in the TEE-Sealed Policy Store, parses verified regulatory text into structured executable policy coefficients, and commits translated coefficients to the TEE-Sealed Policy Store with attestation-bound finality. The engine's translation model is sealed inside the TEE at initialization, and each translation event is cryptographically bound to the TEE attestation report of the hardware environment in which it was performed. Only updates with verified signatures reach the coefficient generation and commitment stages.

FIG. 1C—Compliance Enforcement Gate: Shows the non-bypassable TEE-resident hardware execution barrier that prevents regulated transaction authorization unless all four authorization conditions are satisfied within the same TEE Execution Instance. The gate applies the four-condition evaluation sequence—RCV threshold satisfaction, Policy Drift Monitor integrity confirmation, TEE-Sealed Policy Store attestation currency, and ZKP proof availability—blocking at the first unsatisfied condition and routing failed authorizations to the Rollback Controller with full TEE attestation documentation of the specific condition that prevented authorization.

FIG. 1D—ZKP Compliance Verification Engine: Shows the TEE-resident cryptographic component that generates Groth16 arithmetic-circuit proofs for External Regulatory Authority and auditor verification. The engine encodes regulatory capital threshold conditions, RCV constraint criteria, and TEE-Sealed Policy Store attestation requirements into arithmetic circuit structures, generating proofs of approximately 192 bytes that are verifiable in under 10 milliseconds. No proprietary capital position data, internal model parameters, or counterparty exposure details exit the TEE through the proof generation process.

FIG. 1E—Attestation-Bound Provenance Ledger: Shows the append-only cryptographic hash chain (also referred to as the Provenance Ledger) that permanently records every system action including regulatory update ingestion, policy translation and commitment, RCV computation, Compliance Enforcement Gate authorization or denial, and ZKP proof generation. Each entry is chained to its predecessor using a cryptographic hash, making any alteration of a past entry immediately detectable. Each entry is cryptographically bound to a TEE attestation report, enabling independent verification of both the recorded compliance event and the hardware environment in which it was computed.

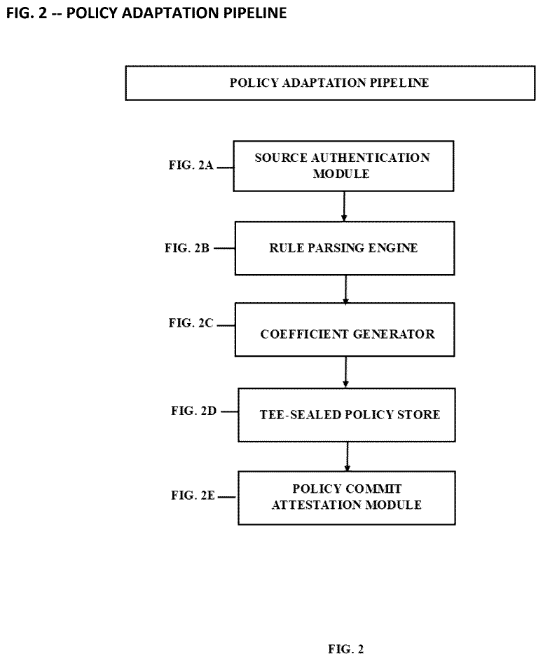

FIG. 2A—Source Authentication Module: Shows the TEE-resident component within the Policy Translation Engine pipeline that extracts and verifies the digital signature of each incoming regulatory update against the applicable External Regulatory Authority's public key stored in the TEE-Sealed Policy Store. The module maintains a TEE-sealed registry of authorized regulatory authority public keys that cannot be modified without generating a new TEE attestation event. Updates whose signatures cannot be verified against an authorized key are rejected before any translation processing occurs.

FIG. 2B—Rule Parsing Engine: Shows the TEE-resident component that parses authenticated regulatory text into structured parameter objects identifying each regulatory coefficient type (capital multiplier, liquidity ratio, stress buffer, or threshold), its applicable scope (instrument type, jurisdiction, institution category), effective date, and transition provisions. The Rule Parsing Engine applies a domain-specific regulatory grammar sealed inside the TEE to extract machine-executable parameter specifications from regulatory document formats including formal rulemaking publications, supervisory guidance, and regulatory technical standards.

FIG. 2C—Coefficient Generator: Shows the component that translates the Rule Parsing Engine's structured parameter objects into the specific numerical coefficient values used by the Regulatory Compliance Vector Engine's compliance function r(lambda, mu, nu, kappa), generating capital multiplier values (mu), stress buffer coefficients (nu), liquidity ratio thresholds, and capital adequacy thresholds (kappa) in the numerical format required by the TEE-Sealed Policy Store and downstream compliance computations.

FIG. 2D—TEE-Sealed Policy Store: Shows the hardware-protected storage repository within the TEE isolation boundary that holds operative regulatory capital multipliers, stress capital buffer coefficients, liquidity coverage ratio thresholds, minimum capital adequacy thresholds, and External Regulatory Authority public keys. The store is accessible only to TEE-resident components and can only be modified through authenticated Policy Translation Engine commitment events. Every modification generates a new TEE attestation report binding the updated parameter state to the hardware environment.

FIG. 2E—Policy Commit Attestation Module: Shows the component that finalizes each Policy Translation Engine commitment event by generating a TEE attestation report binding the newly committed regulatory coefficients to the hardware environment in which the translation and verification were performed, recording the commitment in the Attestation-Bound Provenance Ledger, and updating the TEE-Sealed Policy Store's attestation state indicator to reflect the new parameter version. The attestation report produced by this module is the cryptographic anchor that allows the ZKP Compliance Verification Engine to prove which specific regulatory parameter version governed a particular compliance computation.

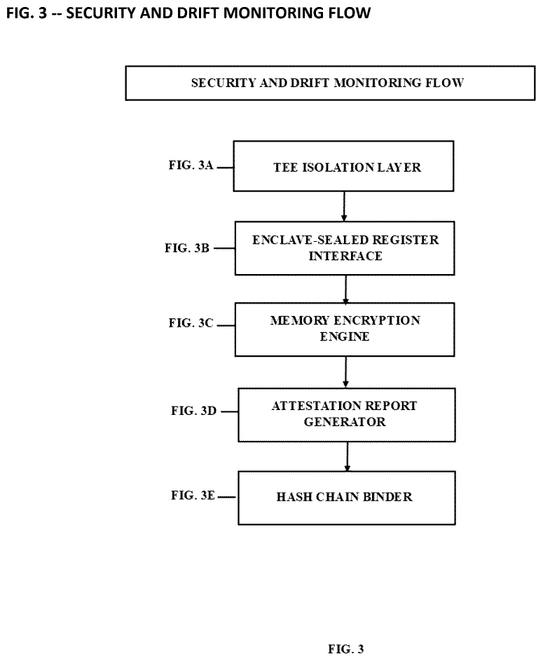

FIG. 3A—TEE Isolation Layer: Shows the hardware isolation boundary that separates all policy translation, regulatory compliance computation, and transaction authorization from the external software environment. The isolation layer encompasses all pipeline components from the Regulatory Feed Ingestion Gate through the Final Compliance Seal. Within this boundary, all computation is protected by the TEE's memory encryption engine, access control registers, and processor privilege enforcement, making it physically impossible for software outside the TEE to observe or modify the TEE-Sealed Policy Store contents, the RCV computation state, or any Compliance Enforcement Gate evaluation at any pipeline stage.

FIG. 3B—Enclave-Sealed Register Interface: Shows the interface through which the Policy Drift Monitor reads hardware-derived integrity signals from the TEE's enclave-sealed monitoring registers. These registers are physically isolated within the processor and inaccessible to software executing outside the TEE. The interface provides the hardware-derived integrity state indicators that drive the Policy Drift Monitor's detection of unauthorized TEE-Sealed Policy Store modifications and trigger the hardware-level policy integrity alert when such modifications are detected.

FIG. 3C—Memory Encryption Engine: Shows the hardware component that encrypts all data stored in the TEE's memory pages, ensuring that regulatory parameter values in the TEE-Sealed Policy Store, capital position data used in RCV computations, and compliance determination state cannot be extracted through physical memory attacks, cold-boot attacks, or hypervisor-level memory inspection. The memory encryption engine provides one of the primary hardware-anchored integrity guarantees on which the Policy Drift Monitor's integrity state monitoring relies.

FIG. 3D—Attestation Report Generator: Shows the component that generates and embeds TEE attestation reports into Policy Commit Attestation Module events, Attestation-Bound Provenance Ledger entries, ZKP proof packages, and Final Compliance Seals. The attestation report is a cryptographically signed statement produced by the TEE hardware signed by the processor manufacturer's root key in the case of Intel SGX or AMD SEV-SNP—that certifies the identity, configuration, and integrity of the software executing inside the TEE, including the current contents of the TEE-Sealed Policy Store. This report enables External Regulatory Authorities and auditors to verify not just the compliance output, but that it was computed using the specific regulatory parameters that were in force in a genuine, unmodified hardware-isolated environment.

FIG. 3E—Policy Drift Monitor: Shows the TEE-resident hardware monitoring component that continuously validates the integrity of the TEE-Sealed Policy Store's regulatory coefficient values by reading hardware-derived signals from enclave-sealed monitoring registers and memory encryption engine integrity states. The monitor detects any deviation in the store's values that was not introduced through an authenticated Policy Translation Engine commitment event and triggers a hardware-level policy integrity alert and Compliance Enforcement Gate suspension until a re-attestation cycle validates the store's contents.

FIG. 4A—Compliance Simulation Engine: Shows the TEE-resident regulatory scenario analysis and capital impact modeling component (also referred to as the Optimization and Simulation Engine) that executes forward-looking compliance scenario simulations inside the hardware isolation boundary. The engine uses hardware-attested RCV values, active regulatory parameters from the TEE-Sealed Policy Store, and proposed future regulatory coefficient scenarios to model the institution's capital position under current and prospective regulatory environments. All simulation outputs are cryptographically bound to the TEE attestation report of the hardware environment that produced them.

FIG. 4B—Regulatory Scenario Stress Tester: Shows the adversarial scenario execution environment within the Compliance Simulation Engine where the institution's capital position is tested against extreme regulatory scenarios—including simultaneous activation of maximum capital buffer requirements, sudden revision of liquidity coverage ratios to peak stressed levels, cross-jurisdiction divergence of capital treatment for specific instrument classes, and rapid-succession regulatory updates—to validate that the system's Policy Translation Engine, TEE-Sealed Policy Store, and Compliance Enforcement Gate remain accurate and responsive under conditions of intense regulatory change activity. Stress test results are recorded in the Attestation-Bound Provenance Ledger with full TEE attestation binding.

FIG. 4C—RCV Calibration Loop: Shows the feedback mechanism through which Regulatory Scenario Stress Tester outputs, post-authorization capital position updates, and Policy Drift Monitor alerts update the Regulatory Compliance Vector Engine's model parameters and the TEE-Sealed Policy Store's calibration baseline. All calibration updates execute inside the TEE, and the updated configuration is cryptographically bound to a new TEE attestation report before any new RCV computation events are processed using the updated parameters.

FIG. 4D—Capital Impact Modeler: Shows the forward-looking component that projects the institution's expected capital adequacy position across configurable time horizons—current quarter, one year, three years, and stress horizon—under both current regulatory parameters and prospective regulatory scenarios loaded from proposed rulemaking sources, enabling proactive compliance planning and early detection of future capital adequacy gaps before regulatory updates take effect.

FIG. 4E—Policy Coefficient Recalibrator: Shows the component that translates Regulatory Scenario Stress Tester outputs and RCV Calibration Loop results into recommended updates to the Regulatory Compliance Vector Engine's internal model parameters and threshold sensitivity settings. Proposed recalibration updates are recorded in the Attestation-Bound Provenance Ledger as pending updates, and the Compliance Enforcement Gate enforces a re-attestation requirement before recalibrated parameters are applied to new transaction authorization events.

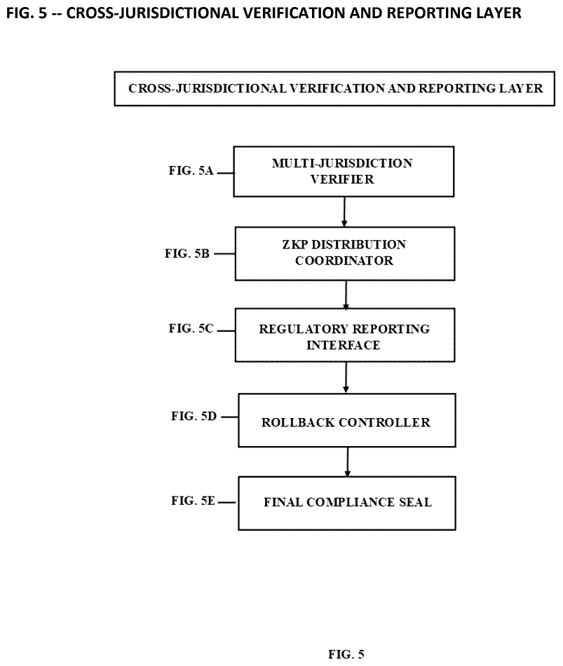

FIG. 5A—Multi-Jurisdiction Verifier: Shows the cross-jurisdictional regulatory compliance verification component that routes TEE-attested RCV computation outcomes and ZKP compliance proofs to applicable External Regulatory Authorities across multiple legal jurisdictions simultaneously. The Multi-Jurisdiction Verifier maintains a routing manifest in the Attestation-Bound Provenance Ledger for end-to-end audit traceability across all participating regulatory authorities, with each routing event recorded and cryptographically bound to the originating TEE attestation report. The component applies jurisdiction-specific regulatory parameter filters to ensure that each External Regulatory Authority receives a compliance proof calibrated to that authority's specific applicable regulatory coefficient set.

FIG. 5B—ZKP Distribution Coordinator: Shows the component that coordinates ZKP proof generation and distribution across multiple External Regulatory Authorities and auditors participating in oversight of a single compliance event or periodic compliance attestation cycle. The ZKP Distribution Coordinator generates authority-specific proofs for each recipient inside the TEE, embedding each authority's applicable regulatory parameter attestation identifiers in the proof's public input set, enabling each authority to independently verify that the compliance computation used the parameters applicable to its specific jurisdiction and supervisory scope.

FIG. 5C—Regulatory Reporting Interface: Shows the auditor-facing and regulator-facing interface that allows authorized External Regulatory Authorities to query the Attestation-Bound Provenance Ledger and verify the history of any regulatory update ingestion, policy translation and commitment, RCV computation, or Compliance Enforcement Gate decision without accessing the institution's proprietary capital position data. The interface returns cryptographically verified summaries drawn directly from the TEE-attested hash chain, with each summary accompanied by the TEE attestation report of the execution instance that produced the underlying record and the attestation identifier of the TEE-Sealed Policy Store update that governed the applicable computation.

FIG. 5D—Rollback Controller: Shows the state reversion mechanism triggered when the Compliance Enforcement Gate blocks transaction authorization, when the Policy Drift Monitor triggers a hardware-level policy integrity alert, or when a compliance event fails External Regulatory Authority ZKP verification. The Rollback Controller reverts all pending pipeline state for the affected transaction to its pre-ingestion checkpoint, records the reversion event in the Attestation-Bound Provenance Ledger with full TEE attestation binding, and initiates a Policy Drift Monitor re-attestation cycle before new transaction authorization processing resumes.

FIG. 5E—Final Compliance Seal: Shows the application of the terminal cryptographic seal to a fully authorized and compliance-verified transaction. Once applied, the seal makes any further modification to the compliance record computationally impossible by anchoring the final hash into the append-only Attestation-Bound Provenance Ledger chain, wherein the final hash is cryptographically bound to the TEE attestation report verifying the hardware environment in which the Policy Translation Engine commitment, RCV computation, Compliance Enforcement Gate authorization, and ZKP proof generation were performed, and includes a reference to the specific TEE-Sealed Policy Store attestation identifier governing the applicable regulatory parameters.

### EXAMPLES OF ENABLEMENT

### Example 1—-Basel IV Capital Multiplier Implementation Across Trading Book (Intel SGX):

A globally active bank receives an authenticated Basel IV Fundamental Review of the Trading Book regulatory update from the relevant External Regulatory Authority, transmitted as a digitally signed regulatory technical standard. The Regulatory Feed Ingestion Gate, executing inside an Intel SGX enclave, receives and normalizes the update, preserving the authority's digital signature metadata. The Policy Translation Engine verifies the signature against the Basel authority public key in the TEE-Sealed Policy Store—verification completes in 8 milliseconds—and parses the update into structured coefficient objects specifying revised capital multipliers (mu) for eight trading book instrument classes, with updated minimum capital adequacy thresholds (kappa) for market risk categories. The Coefficient Generator produces the numerical coefficient values and the Policy Commit Attestation Module commits them to the TEE-Sealed Policy Store, generating a new TEE attestation report with attestation identifier ATTEST-2026-BIV-00341 binding the updated coefficients to the SGX hardware environment. The Attestation-Bound Provenance Ledger records the complete policy update event with the attestation binding. For the next regulated trading book transaction, the Regulatory Compliance Vector Engine computes r(0.82, mu_updated, nu, 0.105)=0.91—-an RCV of 0.91—-against the new minimum threshold of 0.105 under the updated multipliers. The Compliance Enforcement Gate evaluates all four conditions within the same TEE Execution Instance and authorizes the transaction. The ZKP Compliance Verification Engine generates a Groth16 proof of 192 bytes encoding satisfaction of the updated Basel IV thresholds and embedding attestation identifier ATTEST-2026-BIV-00341, transmitted to the applicable External Regulatory Authority and verified in 4 milliseconds. The bank achieves zero-day compliance with the Basel IV update—the updated parameters are enforced as hardware-level execution conditions from the moment the authenticated update is committed—compared to the prior 14-day average implementation cycle for equivalent regulatory parameter updates.

### Example 2—-Unauthorized Policy Coefficient Modification Detection and Recovery (AMD SEV-SNP):

A regional bank operating the Regulatory Capital Adaptation and Policy Orchestration Engine experiences an attempted unauthorized modification of the TEE-Sealed Policy Store. A software deployment error in the bank's infrastructure management system inadvertently writes incorrect capital multiplier values to a configuration repository that an improperly scoped service account attempts to propagate to the compliance system's policy parameters. The Policy Drift Monitor, executing inside an AMD SEV-SNP protected VM, reads through its enclave-sealed monitoring registers and memory encryption engine integrity states that the TEE-Sealed Policy Store's capital multiplier values for two instrument classes have been modified outside an authenticated Policy Translation Engine commitment pathway—the current mu values for those classes do not match the values bound to the most recent Policy Commit Attestation Module attestation report. The Policy Drift Monitor triggers a hardware-level policy integrity alert in 6 milliseconds. The Compliance Enforcement Gate immediately suspends all transaction authorization processing. The Rollback Controller reverts three pending transaction authorization pipeline instances to their pre-ingestion checkpoints. The Attestation-Bound Provenance Ledger records the integrity alert, the specific coefficient deviation detected (mu values for two instrument classes), the three reversion events, and the TEE attestation measurement of the execution instance in which the deviation was detected, all with full AMD SEV-SNP attestation binding. The Policy Drift Monitor initiates a re-attestation cycle: the Policy Translation Engine re-verifies the most recent authenticated regulatory update and recommits the correct coefficients to the TEE-Sealed Policy Store, generating a new attestation report. The Compliance Enforcement Gate resumes processing. The entire detection, suspension, reversion, and documented recovery sequence completes in under 420 milliseconds. The External Regulatory Authority subsequently queries the Attestation-Bound Provenance Ledger through the Regulatory Reporting Interface and receives a cryptographically verified summary confirming that the unauthorized modification was detected and remediated before any non-compliant transaction was authorized.

### Example 3—-Cross-Jurisdiction Simultaneous Regulatory Update Enforcement (ARM TrustZone):

A systemically important global bank operating across seven regulatory jurisdictions receives simultaneous regulatory updates from five External Regulatory Authorities on the same trading day—an unusual but not unprecedented scenario arising from coordinated international regulatory implementation. The updates include revised liquidity coverage ratio thresholds from the EBA, updated stress capital buffer requirements from the Federal Reserve, revised domestic capital multipliers from the PRA, and updated macroprudential buffer requirements from two domestic authorities. The Regulatory Feed Ingestion Gate, executing inside an ARM TrustZone secure world TEE, receives all five updates within a 4-second window and queues them for sequential processing by the Policy Translation Engine. The Policy Translation Engine verifies all five digital signatures against the respective External Regulatory Authority public keys stored in the TEE-Sealed Policy Store—all five verifications pass within 41 milliseconds—and processes the updates in chronological order, generating five sequential Policy Commit Attestation Module events each producing a new TEE attestation report. The TEE-Sealed Policy Store is updated five times within 180 milliseconds, with each update generating a distinct attestation identifier binding the applicable jurisdiction's coefficients to the TrustZone hardware environment. The ZKP Distribution Coordinator generates seven jurisdiction-specific Groth16 compliance proofs for the bank's next regulated transaction—one per applicable regulatory jurisdiction—each embedding the specific attestation identifier of the TEE-Sealed Policy Store update applicable to that jurisdiction's coefficient set. All seven proofs are distributed to the applicable regulatory verification systems via the Multi-Jurisdiction Verifier; all seven are verified in under 7 milliseconds per proof. The Regulatory Reporting Interface makes the complete five-update policy adaptation record available to all five regulatory authorities within 2 seconds of the last update commitment, with each authority receiving only the provenance records relevant to its own update. The bank achieves zero-day enforcement of all five simultaneous regulatory updates—a capability that required a minimum of 8 days per update under the prior manual compliance implementation workflow.

What is claimed is:

1. A hardware-secured regulatory capital adaptation and policy orchestration system comprising a trusted execution environment (TEE) comprising an Intel SGX enclave, AMD SEV-SNP protected VM, or ARM TrustZone secure world materially altering the processor state by invoking secure enclave isolation, the TEE executing a Regulatory Feed Ingestion Gate configured to receive and normalize authenticated regulatory updates with digital signature metadata preserved; a Policy Translation Engine executing within the TEE configured to verify each regulatory update's digital signature against External Regulatory Authority public keys stored in a TEE-Sealed Policy Store, to parse verified regulatory text into structured executable policy coefficients comprising capital multipliers, stress capital buffer coefficients, liquidity coverage ratio thresholds, and minimum capital adequacy thresholds, and to commit translated coefficients to the TEE-Sealed Policy Store with a new TEE attestation report binding the updated coefficients to the hardware environment; a Policy Drift Monitor executing within the TEE anchored to TEE-resident hardware mechanisms comprising enclave-sealed monitoring registers, memory encryption engine integrity states, or attestation-based recalibration triggers, configured to detect unauthorized modification of TEE-Sealed Policy Store contents and to trigger a hardware-level policy integrity alert upon detection; a Compliance Enforcement Gate executing within the TEE configured to prevent transaction authorization absent satisfaction of Regulatory Compliance Vector thresholds derived from the TEE-Sealed Policy Store, wherein all RCV computation, Policy Drift Monitor validation, and gate evaluation operations complete within a single attested TEE execution instance prior to enclave termination; an Attestation-Bound Provenance Ledger comprising an append-only cryptographic hash chain wherein each entry is cryptographically bound to a TEE attestation report corresponding to the hardware environment in which the associated computation was performed; and a ZKP Compliance Verification Engine executing within the TEE configured to generate Groth16 arithmetic-circuit proofs of approximately 192 bytes verifiable in under 10 milliseconds on standard server-grade hardware, wherein each proof embeds the attestation identifier of the TEE-Sealed Policy Store update governing the applicable compliance computation, enabling External Regulatory Authority verification of regulatory compliance without exposure of proprietary capital position data.

2. A method of hardware-secured regulatory capital adaptation and compliance enforcement comprising receiving authenticated regulatory updates with digital signature metadata at a Regulatory Feed Ingestion Gate executing within a trusted execution environment (TEE) comprising an Intel SGX enclave, AMD SEV-SNP protected VM, or ARM TrustZone secure world materially altering the processor state by invoking secure enclave isolation; verifying each regulatory update's digital signature within the TEE against External Regulatory Authority public keys stored in a TEE-Sealed Policy Store; translating verified regulatory text within the TEE into structured executable policy coefficients comprising capital multipliers, stress capital buffer coefficients, and capital adequacy thresholds; committing translated coefficients to the TEE-Sealed Policy Store with a new TEE attestation report binding the updated coefficients to the hardware environment; anchoring policy integrity monitoring to TEE-resident hardware mechanisms comprising enclave-sealed monitoring registers, memory encryption engine integrity states, or attestation-based recalibration triggers to detect unauthorized modification of TEE-Sealed Policy Store contents; computing a Regulatory Compliance Vector within the TEE using the regulatory compliance function r(lambda, mu, nu, kappa) from the committed policy coefficients; evaluating all Compliance Enforcement Gate authorization conditions within the same TEE execution instance; generating Groth16 arithmetic-circuit proofs of approximately 192 bytes verifiable in under 10 milliseconds embedding the attestation identifier of the applicable TEE-Sealed Policy Store update; and recording all policy adaptation and compliance enforcement events in an append-only Attestation-Bound Provenance Ledger with cryptographic hash chain entries bound to TEE attestation reports.

3. A hardware-secured regulatory policy enforcement and compliance automation subsystem comprising a trusted execution environment (TEE) comprising an Intel SGX enclave, AMD SEV-SNP protected VM, or ARM TrustZone secure world materially altering the processor state by invoking secure enclave isolation; a TEE-Sealed Policy Store holding operative regulatory capital multipliers, stress capital buffer coefficients, liquidity coverage ratio thresholds, minimum capital adequacy thresholds, and External Regulatory Authority public keys, wherein the store is modifiable exclusively through authenticated Policy Translation Engine commitment events each generating a new TEE attestation report, and wherein any modification outside this pathway triggers a hardware-level alert from the Policy Drift Monitor anchored to TEE-resident hardware mechanisms; a Compliance Enforcement Gate executing within the TEE configured to enforce active regulatory capital requirements as non-bypassable hardware-level preconditions to transaction authorization, evaluating Regulatory Compliance Vector threshold satisfaction, Policy Drift Monitor integrity confirmation, and TEE-Sealed Policy Store attestation currency within a single attested TEE execution instance prior to enclave termination; a Compliance Simulation Engine (also referred to herein as the Optimization and Simulation Engine) executing within the TEE configured to execute forward-looking regulatory compliance scenario simulations and capital impact analyses using hardware-attested Regulatory Compliance Vector values and TEE-Sealed Policy Store parameters; and an Attestation-Bound Provenance Ledger comprising an append-only cryptographic hash chain wherein each entry is cryptographically bound to a TEE attestation report and includes a reference to the specific TEE-Sealed Policy Store attestation identifier governing the applicable regulatory parameters, enabling independent verification of both the compliance outcome and the regulatory parameter version that governed it.

4. The system of claim 1, wherein the ZKP Compliance Verification Engine encodes regulatory capital threshold conditions, Regulatory Compliance Vector constraint criteria, and TEE-Sealed Policy Store attestation requirements into Groth16 arithmetic circuit structures using cryptographic libraries including libsnark and circom, with Groth16 constant-size verification complexity independent of circuit depth ensuring the under-10-millisecond verification bound holds across all supported compliance circuit configurations on standard server-grade hardware.

5. The system of claim 1, wherein the TEE-resident hardware mechanisms include memory encryption engine integrity states that encrypt all data stored in TEE memory pages, preventing extraction of TEE-Sealed Policy Store regulatory coefficients, capital position computation state, or Regulatory Compliance Vector values through physical memory attacks, cold-boot attacks, or hypervisor-level memory inspection.

6. The system of claim 1, wherein the Policy Drift Monitor triggers a hardware-level policy integrity alert and suspends Compliance Enforcement Gate authorization when unauthorized modification of TEE-Sealed Policy Store contents is detected via TEE-resident hardware mechanisms, requiring a Policy Translation Engine re-attestation cycle generating a new TEE attestation report confirming the store's validated contents before transaction authorization processing resumes.

7. The system of claim 1, wherein the Policy Translation Engine applies a domain-specific regulatory grammar sealed inside the TEE to parse regulatory document formats including formal rulemaking publications, supervisory guidance, and regulatory technical standards into structured parameter objects identifying each coefficient type, applicable scope, effective date, and transition provisions.

8. The system of claim 1, wherein each Attestation-Bound Provenance Ledger entry comprises a cryptographic hash of the prior ledger entry chained with the TEE attestation measurement of the current TEE execution instance and the attestation identifier of the TEE-Sealed Policy Store update governing the applicable computation, such that modification of any historical entry propagates as a detectable hash chain inconsistency through all subsequent entries.

9. The system of claim 1, wherein the ZKP Compliance Verification Engine implements Groth16 proofs using trusted setup ceremonies performed inside a TEE, with proving key rotation tied to hardware attestation events and TEE-Sealed Policy Store update events, and prior proving keys invalidated using enclave-sealed revocation lists.

10. The system of claim 1, further comprising a Compliance Simulation Engine executing within the TEE configured to execute forward-looking regulatory compliance scenario simulations and capital impact analyses under proposed future regulatory coefficient scenarios, generating capital adequacy projections cryptographically bound to the TEE attestation report of the simulation execution instance.

11. The system of claim 1, wherein the Compliance Enforcement Gate enforces a mandatory execution barrier requiring that Regulatory Compliance Vector computation, Policy Drift Monitor validation, TEE-Sealed Policy Store attestation currency confirmation, and ZKP proof generation complete within a single attested TEE execution instance prior to enclave termination before any transaction authorization is released, with any incomplete or failed pipeline stage triggering the Rollback Controller.

12. The method of claim 2, wherein detecting unauthorized modification of TEE-Sealed Policy Store contents triggers a Policy Translation Engine re-attestation cycle using enclave-sealed monitoring registers, suspending transaction authorization until a new TEE attestation report is generated confirming the store's validated regulatory coefficient contents.

13. The method of claim 2, wherein the Groth16 arithmetic-circuit proofs exhibit constant-size verification complexity independent of circuit depth, and wherein each proof embeds the attestation identifier of the TEE-Sealed Policy Store update in force at the time of the compliance computation, enabling External Regulatory Authorities to verify both threshold satisfaction and the specific regulatory parameter version governing the computation.

14. The method of claim 2, further comprising generating jurisdiction-specific Groth16 compliance proofs for multiple External Regulatory Authorities simultaneously, each embedding the attestation identifier of the TEE-Sealed Policy Store update applicable to that authority's specific regulatory coefficient set, enabling each authority to independently verify jurisdiction-specific compliance without accessing other jurisdictions' compliance data.

15. The system of claim 3, further comprising a Multi-Jurisdiction Verifier configured to route TEE-attested compliance outcomes and ZKP proofs with jurisdiction-specific TEE-Sealed Policy Store attestation identifiers to applicable External Regulatory Authorities across multiple legal jurisdictions, maintaining a routing manifest in the Attestation-Bound Provenance Ledger with cryptographic binding to the originating TEE attestation report for each routing event.

16. The system of claim 3, further comprising a ZKP Distribution Coordinator executing within the TEE configured to generate authority-specific Groth16 compliance proofs for multiple External Regulatory Authorities participating in oversight of a single compliance event, each proof embedding that authority's applicable regulatory parameter attestation identifiers, enabling independent verification of jurisdiction-specific compliance by each authority without cross-jurisdiction data disclosure.

17. The system of claim 3, further comprising a Rollback Controller executing within the TEE configured to revert pending pipeline state to a pre-ingestion checkpoint upon Compliance Enforcement Gate denial or Policy Drift Monitor hardware integrity alert, recording the reversion event in the Attestation-Bound Provenance Ledger with full TEE attestation binding and the attestation identifier of the TEE-Sealed Policy Store update in force at the time of the reversion event.

18. The system of claim 3, further comprising an RCV Calibration Loop executing within the TEE configured to incorporate Regulatory Scenario Stress Tester outputs, post-authorization capital position updates, and Policy Drift Monitor alerts into Regulatory Compliance Vector Engine model parameter updates, with all calibration updates cryptographically bound to a new TEE attestation report before application to subsequent RCV computation events.

19. The system of claim 3, further comprising a Policy Coefficient Recalibrator executing within the TEE configured to translate Compliance Simulation Engine scenario outputs into recommended sensitivity adjustments for the Regulatory Compliance Vector Engine's threshold application parameters, with proposed adjustments requiring Compliance Enforcement Gate re-attestation confirming generation of a new TEE attestation report before application to new transaction authorization events.

20. The system of claim 3, wherein the Attestation-Bound Provenance Ledger records each regulatory parameter update, compliance computation, and transaction authorization event with cryptographic hash-chain binding to both the TEE attestation report identifier of the TEE execution instance that performed the computation and the TEE-Sealed Policy Store attestation identifier of the regulatory parameter version that governed it, enabling independent verification of the complete provenance chain from External Regulatory Authority rule issuance through authenticated policy translation through hardware-attested compliance enforcement for each authorized transaction.
